(19) United States
(12) Patent Application Publication
(10) Pub. No.: US 2025/0392241 A1
(43) Pub. Date: Dec. 25, 2025

(54) MOTION SENSING DIAGNOSTICS FOR PERMANENT MAGNET DC MOTOR DRIVE

(71) Applicant: Steering Solutions IP Holding Corporation, Saginaw, MI (US)

(72) Inventors: Prerit Pramod, Bellevue, WA (US); Siddharth Mehta, Auburn Hills, MI (US); Vidit V. Pandya, Auburn Hills, MI (US); Chethan Narayanaswamy, Auburn Hills, MI (US); Joshua D. Kirk, Frankenmuth, MI (US)

(21) Appl. No.: 18/749,862

(22) Filed: Jun. 21, 2024

(51) Int. Cl. H02P 21/18; H02P 6/00

(52) U.S. Cl. CPC H02P 21/18; H02P 6/006

(57) ABSTRACT

Technical solutions are described for diagnosing a sensor error in an actuator having a permanent magnet DC (PMDC) motor, including: measuring, by a position sensor, a measured position of the PMDC motor; determining, based on the measured position, an estimated motor velocity; measuring, by a current sensor, a measured current in the PMDC motor; determining, based on the measured current in the PMDC motor, a voltage command for the PMDC motor; determining, based on the measured current and the voltage command, and using a motor velocity observer, an observed velocity of the PMDC motor; determining a difference velocity as a difference between the estimated motor velocity and the observed velocity; determining, based on the difference velocity, the sensor error; and performing an action in response to determining the sensor error.

### BACKGROUND

The present disclosure relates to methods and systems for diagnosing motion sensors for permanent magnet DC motors, such as brushed DC motors.

Permanent magnet DC motors, such as brushed DC motors are used in various applications. One such application for permanent magnet DC motors is in power steering systems for vehicles. Column adjustment actuators provide the ability to dynamically adjust the spatial location of the steering handwheel to enhance driver comfort and safety. Such dual trajectory control is achieved through the regulation of the translational position of the rake and telescope actuators for vertical and horizontal motion respectively. Permanent magnet DC (PMDC) motor drives, coupled to leadscrew mechanisms, are typically employed to generate the requisite force, which is in-turn determined by the position controller acting in part on an estimated translational position signal. In cost optimized applications, a single rotational position encoder to measure the motor position is included, which leaves the overall mechanism susceptible to single point failures that can, at times, be hazardous.

### SUMMARY

According to one or more embodiments, a method of diagnosing a sensor error in an actuator having a permanent magnet DC (PMDC) motor includes: measuring, by a position sensor, a measured position of the PMDC motor; determining, based on the measured position, an estimated motor velocity; measuring, by a current sensor, a measured current in the PMDC motor; determining, based on the measured current in the PMDC motor, a voltage command for the PMDC motor; determining, based on the measured current and the voltage command, and using a motor velocity observer, an observed velocity of the PMDC motor; determining a difference velocity as a difference between the estimated motor velocity and the observed velocity; determining, based on the difference velocity, the sensor error; and performing an action in response to determining the sensor error.

According to one or more embodiments, a motor control system includes: a position sensor configured to measure a measured position of a PMDC motor; a current sensor configured to measure a measured current in the PMDC motor; and a controller. The controller is configured to: determine, based on the measured position, an estimated motor velocity; determine, based on the measured current in the PMDC motor, a voltage command for the PMDC motor; determine, based on the measured current and the voltage command, and using a motor velocity observer, an observed velocity of the PMDC motor; determine a difference velocity as a difference between the estimated motor velocity and the observed velocity; determine, based on the difference velocity, a sensor error; and perform an action in response to determining the sensor error.

According to one or more embodiments, a motor control system includes: a position sensor configured to measure a measured position of a PMDC motor; a current sensor configured to measure a measured current in the PMDC motor; a processor; and a memory. The memory includes instructions that, when executed by the processor, cause the processor to: determine, based on the measured position, an estimated motor velocity; determine, based on the measured current in the PMDC motor, a voltage command for the PMDC motor; determine, based on the measured current and the voltage command, and using a motor velocity observer, an observed velocity of the PMDC motor; determine a difference velocity as a difference between the estimated motor velocity and the observed velocity; determine, based on the difference velocity, a sensor error; and perform an action in response to determining the sensor error.

These and other advantages and features will become more apparent from the following description taken in conjunction with the drawings.

### BRIEF DESCRIPTION OF THE DRAWINGS

The subject matter of the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 shows a column position module (CPM) of a steering system in a vehicle, according to aspects of the present disclosure;

FIG. 2 shows a schematic block diagram of a motor control system for controlling a brushed permanent magnet direct current (PMDC) motor, according to aspects of the present disclosure;

FIG. 3 shows an electrical schematic diagram of a control system for a brushed DC motor, according to aspects of the present disclosure;

FIG. 4 shows a schematic block diagram of a motion sensing diagnostic controller for a PMDC motor, according to aspects of the present disclosure;

FIG. 5 shows a schematic block diagram of a PMDC motor, according to aspects of the present disclosure;

FIG. 6 shows a block diagram indicating structure and data flow of a state observer, according to aspects of the present disclosure;

FIG. 7 shows a schematic block diagram of a motor control system with a disturbance state observer and a velocity estimator, according to aspects of the present disclosure;

FIG. 8 shows a schematic block diagram of a motor control system with a disturbance state observer and a velocity estimator, according to aspects of the present disclosure;

FIG. 9 shows a graph illustrating actual and estimated motor positions over time, according to aspects of the present disclosure;

FIG. 10 shows a graph illustrating true velocity, observed velocity, and estimated motor velocity of a PMDC motor, according to aspects of the present disclosure;

FIG. 11 shows a graph illustrating a difference velocity over a same time period as the graph of FIG. 10;

FIG. 12 shows a flow diagram listing steps in a method of diagnosing a sensor error in an actuator having a PMDC motor, according to aspects of the present disclosure.

### DETAILED DESCRIPTION

Referring now to the figures, where the present disclosure will be described with reference to specific embodiments, without limiting the same, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

As used herein the terms module and sub-module refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the sub-modules described below can be combined and/or further partitioned.

The present disclosure provides a motion sensing diagnostic scheme that utilizes an observer to estimate a velocity of a permanent magnet DC (PMDC) motor in an actuator. The observed velocity is compared to an estimated motor velocity computed from the position sensor, in conjunction with adaptive threshold adjustments to detect a malfunction of the position sensor, and thus improve system safety.

The adaptive threshold may be implemented to prevent false detection of a malfunction, which could otherwise be triggered in certain circumstances. For example, at very low velocities, the estimated velocity of the actuator may be inaccurate, so the adaptive threshold may be set relatively high to prevent false alerts that could otherwise result. Additionally or alternatively, inaccurate resistance estimation and/or inductance estimation may cause inaccuracy in the observed velocity during certain conditions, and the adaptive threshold may be configured to prevent corresponding false alerts that could otherwise result.

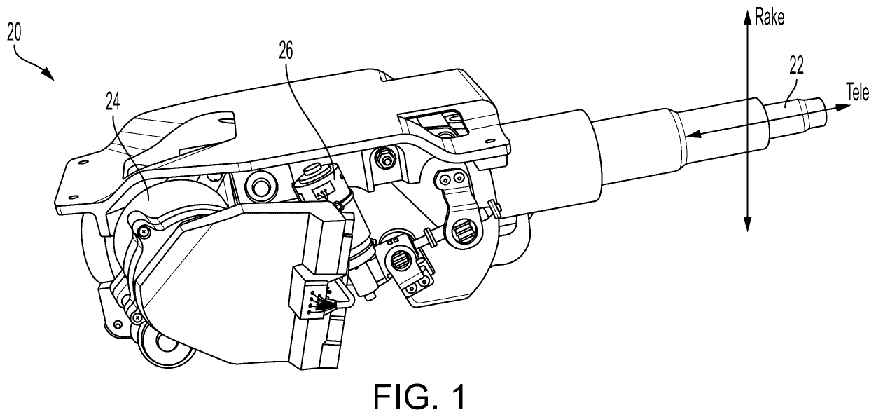

Referring now to the figures, where the technical solutions will be described with reference to specific embodiments, without limiting same, FIG. 1 shows an exemplary embodiment of a column position module (CPM) 20 of a steering system in a vehicle, and which may utilize the disclosed systems and methods for controlling a PMDC motor.

The CPM 20 includes a steering shaft 22 configured to attach to a steering wheel, which may also be called a hand wheel, that can be used by a person for steering a vehicle. The CPM 20 includes a steering actuator 24 attached to the steering shaft. The steering actuator 24 may supplement the person's application of force in order to provide power-assisted steering function. The CPM 20 also includes a rake actuator motor 26 configured to control a vertical position of the handwheel by moving an end the steering shaft in a radial direction. The CPM 20 also includes a telescoping actuator motor 28 (not shown on FIG. 1) that is configured to control an axial position of the handwheel by moving the steering shaft 22 in an axial direction.

Any or all of the steering actuator 24, the rake actuator motor 26 and/or the telescoping actuator motor 28 may include brushed DC motors and may be controlled using the systems and methods of the present disclosure. However, the systems and methods of the present disclosure may be used with brushed DC motors in other applications in a vehicle, such as for a steering actuator in an electric power steering (EPS) system. The systems and methods of the present disclosure are not limited to use in vehicles, and may be used with PMDC motors in a variety of different applications.

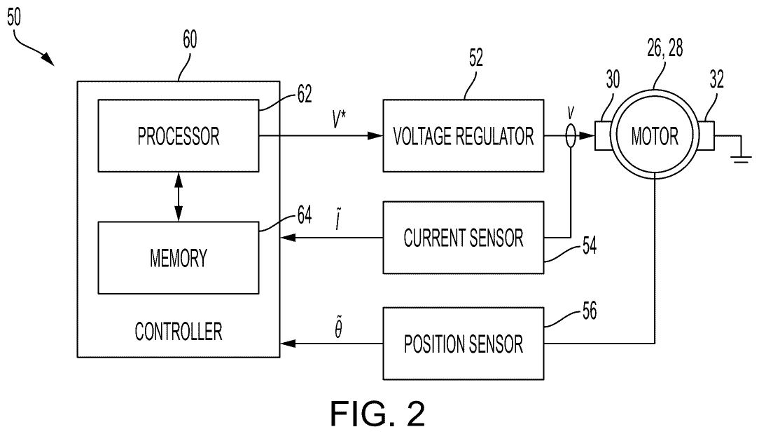

FIG. 2 shows a schematic block diagram of a motor control system 50 for controlling a PMDC motor 26, 28. In some embodiments, and as shown in FIG. 2, the PMDC motor 26, 28 is a brushed DC motor having a set of brushes 30, 32 for transmitting DC current from a stationary terminal to a rotor winding of the PMDC motor 26, 28. The set of brushes 30, 32 includes a first brush 30 configured to be connected to a power source for receiving a DC current. The set of brushes 30, 32 also includes a second brush 32 configured to be connected to a current sink, such as a ground terminal.

The motor control system 50 includes a controller 60. The controller 60 may include any suitable controller, such as an electronic control unit or other suitable controller. The controller 60 may be configured to control, for example, the various functions of the steering system and/or various functions of a vehicle. The controller 60 may include a processor 62 and a memory 64. The processor 62 may include any suitable processor, such as those described herein. Additionally, or alternatively, the controller 60 may include any suitable number of processors, in addition to or other than the processor 62. The memory 64 may comprise a single disk, a plurality of disks (e.g., hard drives) and/or an electronic non-volatile computer memory storage medium such as a Flash memory device. In some embodiments, memory 64 may include flash memory, semiconductor (solid state) memory or the like. The memory 64 may include Random Access Memory (RAM), a Read-Only Memory (ROM), or a combination thereof. The memory 64 may include instructions that, when executed by the processor 62, cause the processor 62 to, at least, control various aspects of the vehicle. Additionally, or alternatively, the memory 64 may include instructions that, when executed by the processor 62, cause the processor 62 to perform functions associated with the systems and methods described herein.

The controller 60 may be operably connected to a voltage regulator 52. The voltage regulator 52 may be configured to apply a DC voltage v to the first brush 30 of the PMDC motor 26, 28. The voltage regulator 52 may generate the DC voltage v based on a voltage command V* from the controller 60.

In some embodiments, and as shown in FIG. 2, the motor control system 50 may include a current sensor 54 configured to measure the DC current supplied to the PMDC motor 26, 28 and to transmit a motor current signal Ĩ to the controller 60, representing an actual motor current in a winding of the PMDC motor 26, 28. Additionally or alternatively, and as also shown in FIG. 2, the motor control system 50 may include a position sensor 56 and configured to measure a rotational position of the PMDC motor 26, 28 and to transmit a motor position signal \tilde{θ} to the controller 60.

In some embodiments, the controller 60 may perform the methods described herein. However, the methods described herein as performed by the controller 60 are not meant to be limiting, and any type of software executed on a controller or processor can perform the methods described herein without departing from the scope of this disclosure. For example, a controller, such as a processor executing software within a computing device, can perform the methods described herein.

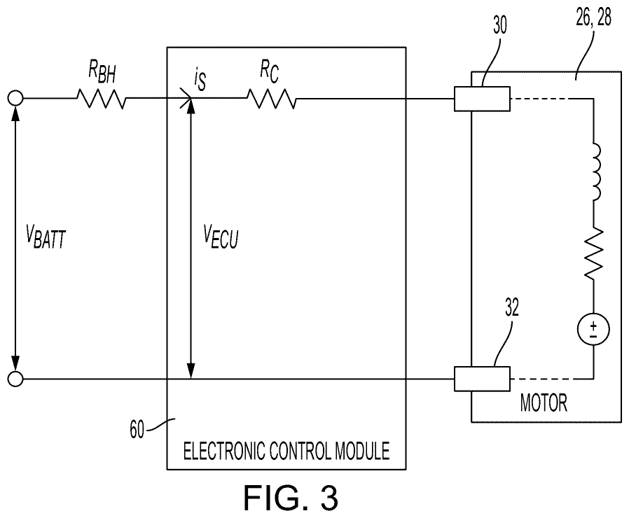

FIG. 3 shows an electrical schematic diagram of a control system for a PMDC motor 26, 28. As shown, the controller 60 and the PMDC motor 26, 28 define a voltage loop having a supply current i_{S}, and defining a battery voltage V_{BATT} across a power source (not shown), and a controller supply voltage V_{ECU} across the controller 60. As shown in FIG. 3, the voltage loop includes a battery harness resistance R_{BH} in a current path between the battery and the controller 60. The voltage loop also includes a controller input resistance R_{C} within the controller 60, in series with the battery harness resistance R_{BH}. The PMDC motor 26, 28 is shown in FIG. 3 as including an inductor, a resistor, and a voltage source, connected in series and representing winding inductance, coil resistance, and back-EMF, respectively.

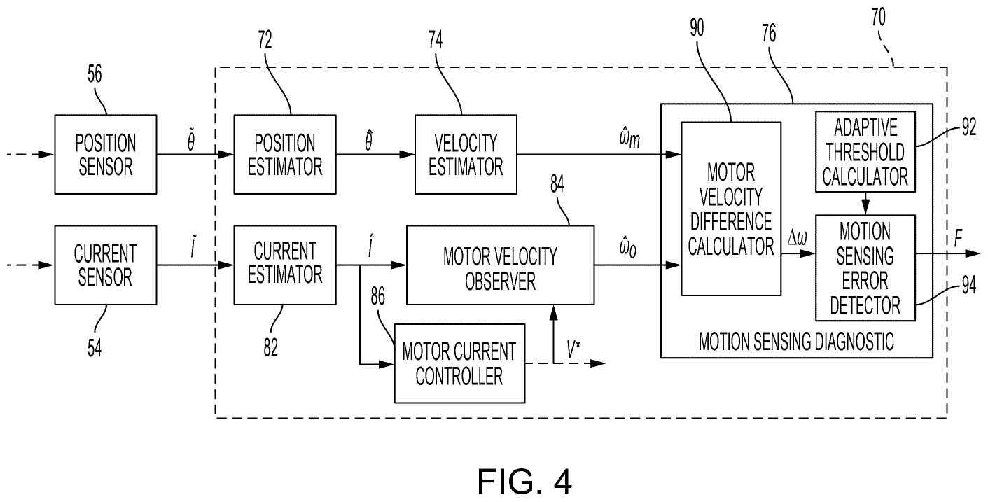

FIG. 4 shows a schematic block diagram of a motion sensing diagnostic controller 70 for a PMDC motor. The motion sensing diagnostic controller 70 may be implemented in software, hardware, or a combination of hardware and software. In some embodiments, the processor 62 may execute instructions to implement the motion sensing diagnostic controller 70. The motion sensing diagnostic controller 70 takes, as inputs, the motor position signal \tilde{θ} from the position sensor 56 and the motor current signal Ĩ from the current sensor 54.

The motion sensing diagnostic controller 70 includes a position estimator 72 that is configured to determine an estimated motor position \hat{θ} based on the motor position signal \tilde{θ} from the position sensor 56. For example, the position estimator 72 may calculate the estimated motor position \hat{θ} by applying a scale factor and/or an offset to the motor position signal \tilde{θ}. The motion sensing diagnostic controller 70 includes a current estimator 82 that is configured to determine an estimated motor current Î based on the motor current signal Ĩ from the current sensor 54. For example, the current estimator 82 may calculate the estimated motor current Î by applying a scale factor and/or an offset to the motor current signal Ĩ.

The motion sensing diagnostic controller 70 also includes a velocity estimator 74 that is configured to determine the estimated motor velocity \hat{ω}ₘ based on the estimated motor position \hat{θ}. For example, the velocity estimator 74 may compute the estimated motor velocity \hat{ω}ₘ as a derivative of the estimated motor position \hat{θ}, over time.

In some cases, the motor position signal \tilde{θ} may have a relatively low resolution when the PMDC motor 26, 28 has a relatively low velocity. For example, where the position sensor 56 includes a position encoder, the resolution of the position signal \tilde{θ} may be low at lower velocities. Thus, the estimated motor velocity \hat{ω}ₘ may have significant quantization noise. If a simple derivative operator consisting of a pure derivative along with a low pass filter is used, the resulting velocity noise is reduced at the cost of degraded estimation dynamics. The velocity error threshold may be adjusted based on a rotational velocity of the PMDC motor 26, 28 to avoid false indication of a sensor error. The velocity error threshold may be adjusted based on the observed velocity \hat{ω}ₒ. For example, the velocity error threshold may be increased or set to predetermined value when the observed velocity \hat{ω}ₒ is below a low velocity threshold value.

The motion sensing diagnostic controller 70 also includes a motor velocity observer 84 that is configured to determine an observer-based velocity, which may also be called an observed velocity \hat{ω}ₒ, based on the estimated motor current Î. For example, the motor velocity observer 84 may compute the observed velocity \hat{ω}ₒ using a motor electromagnetic model based disturbance observer. However, different observer designs may be used in order to calculate the observed velocity \hat{ω}ₒ. The motion sensing diagnostic controller 70 also includes a motor current controller 86 that is configured to determine a voltage command V* based on the estimated motor current Î. The voltage command V* may be sent to the voltage regulator 52 for generating the DC voltage to be applied to the PMDC motor 26, 28. In some embodiments, and as shown in FIG. 4, the voltage command V* is also sent to the motor velocity observer 84, and the motor velocity observer determines the observed velocity \hat{ω}ₒ further based on the voltage command V*.

The motion sensing diagnostic controller 70 also includes a motion sensing diagnostic component 76 that is configured to selectively indicate a sensor error based on the observed velocity \hat{ω}ₒ and the estimated motor velocity \hat{ω}ₘ. The motion sensing diagnostic component 76 includes a velocity difference calculator 90 that is configured to determine a difference velocity Δω as a difference between the observed velocity \hat{ω}ₒ and the estimated motor velocity \hat{ω}ₘ. The motion sensing diagnostic component 76 also includes a motion sensing error detector 94 that is configured to selectively generate a fault signal F when the difference velocity Δω exceeds a velocity error threshold. For example, the motion sensing error detector 94 may include a comparator configured to compare the difference velocity Δω exceeds a value of the velocity error threshold. The fault signal F may, therefore, indicate a failure with the position sensor 56.

One or more actions may be performed based on the fault signal F. For example, the controller 60 may generate a diagnostic trouble code (DTC) and/or generate a warning message to notify an operator of the sensor error. In some embodiments, the controller 60 may communicate a message to an external controller, such as a supervisory controller regarding the fault signal F. In some embodiments, the controller 60 may perform one or more actions to mitigate effects of the sensor error, such as operating the PMDC motor in a reduced capacity, using a redundant motor instead of the PMDC motor 26, 28, or controlling operation of the PMDC motor 26, 28 based on the observed velocity \hat{ω}ₒ.

In some embodiments, and as shown in FIG. 4, the motion sensing diagnostic component 76 also includes an adaptive threshold calculator 92 that is configured to adjust the velocity error threshold value. For example, the adaptive threshold calculator 92 may dynamically adjust the velocity error threshold based on the operating condition of the actuator. Since the expected velocity error at any instant is dependent on the type of position sensor, structure of the velocity estimator 74, and the characteristics of the motor velocity observer 84, the velocity error threshold may be determined based on available signals that provide such information.

The observer is susceptible to errors in motor parameter estimation which are, in-turn, dependent on the motor current and temperature, so scheme to adjust the velocity error threshold, using appropriate signals, may be employed to enhance the diagnostic robustness.

In a sensor-based velocity estimation technique, a measured motor position \tilde{θ} is utilized to determine the estimated motor velocity \hat{ω}ₘ, as shown in FIG. 4. The estimated motor velocity \hat{ω}ₘ of the PMDC motor 26, 28 may be determined based on the motor position signal \tilde{θ} from the position sensor 56 and using a derivative ŝ with a low pass filter. The derivative term may be approximated using different techniques and may be written as equation (1):

$$\hat{s} = \frac{s}{τ s + 1} \qquad ( 1 )$$

The low-pass filter frequency for the derivative approximation must be chosen carefully to attenuate noise in the estimated signal. The low-pass filter frequency may be determined by performing sensitivity analysis for a given application.

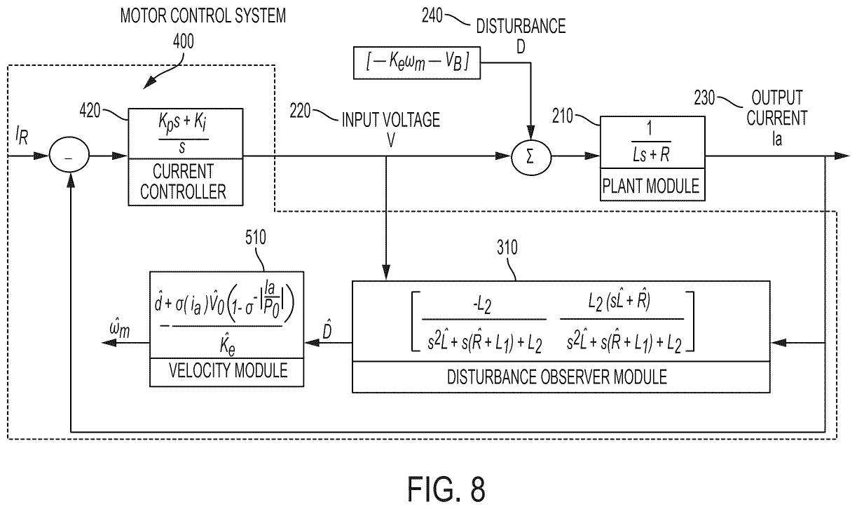

The present disclosure provides an observer-based estimation approach for determining the observed velocity \hat{ω}ₒ based on current sensor information and the commanded voltage V*, as shown FIG. 4. One such approach is described herein with reference to FIG. 8, where a disturbance observer is implemented to estimate motor velocity. The disturbance observer may be implemented using equation (2). However, different observer designs may be used in order to calculate the observed velocity \hat{ω}ₒ.

$$[ \begin{matrix}{\dot{\hat{I}}}_{a} \\ \dot{\hat{d}}\end{matrix} ] = [ \begin{matrix}- \frac{\hat{R}}{\hat{L}} & \frac{1}{\hat{L}} \\ 0 & 0\end{matrix} ] [ \begin{matrix}\frac{1}{\hat{L}} \\ 0\end{matrix} ] {V}^{*} + [ \begin{matrix}{L}_{1} \\ {L}_{2}\end{matrix} ] ( {I}_{a} - {\hat{I}}_{a} ) \qquad ( 2 )$$

where \hat{R} and \hat{L} represent the motor resistance and inductance estimates, respectively, \hat{d}, V*, Iₐ and Îₐ represent the observed disturbance, command voltage, actual motor current and estimated motor current, respectively, and L₁,L₂ represent the observer gains. The observed disturbance \hat{d} may represent a combination of back-EMF, and brush voltage drop \hat{V}_{B}.

Subsequently, the observed velocity \hat{ω}ₒ can be extracted using equation (3):

$${\hat{ω}}_{o} = \frac{\hat{d} + {\hat{V}}_{B}}{{\hat{K}}_{e}} \qquad ( 3 )$$

where \hat{V}_{B} and \hat{K}ₑ represent the brush voltage drop and back EMF constant estimates for the motor, respectively. Both the velocity estimates are subsequently utilized to calculate a difference velocity Δω in real time as shown in equation (4). This aids in indicating faults under position sensor failures as the observed velocity \hat{ω}ₒ is independent of the position sensor measurements.

$$Δ ω = {\hat{ω}}_{o} - {\hat{ω}}_{m} \qquad ( 4 )$$

where the difference velocity Δω represents a difference between the observed velocity \hat{ω}ₒ and the estimated motor velocity \hat{ω}ₘ, which is based on a measurement from a sensor. Under normal operation, the difference velocity Δω should be within a velocity error threshold. However, during position sensor failure, Aw may exceed the velocity error threshold. The velocity error threshold may be dependent on a type of position sensor, type of velocity estimation technique and/or observer design. In some embodiments, the velocity error threshold may be dynamically adjusted.

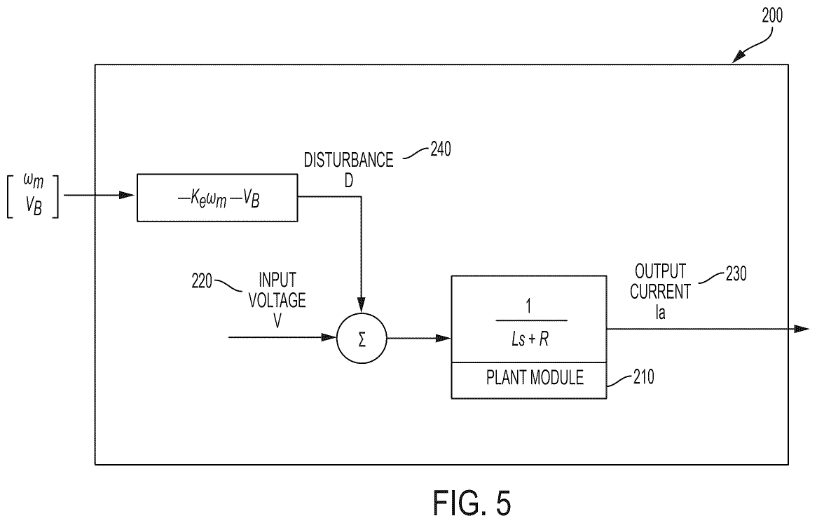

FIG. 5 shows a schematic block diagram of a plant model of a brushed PMDC motor 200, which may represent the PMDC motor 26, 28 of the CPM 20, according to aspects of the present disclosure.

A plant model of an electrical subsystem of the brushed PMDC motor 200 is represented in part by a plant module 210. In one or more examples, the plant module 210 models the electrical subsystem of a PMDC motor 26, 28. The plant module 210 receives a voltage signal 220 (V) as input and generates a current signal 230 (Iₐ) as output. In one or more examples, a disturbance estimate 240 (D) affects the voltage signal 220, as illustrated. The disturbance estimate 240 can be a sum of BEMF and brush drop voltage v_{B}. In one or more examples, the PMDC motor 200 includes additional components, such as a delay compensation module, and so on.

Typically, an observer design is performed by utilizing a model of the plant whose state variable is to be extracted. In the case of the PMDC motor 26, 28, the plant is the electrical sub-system of the PMDC motor, which can be modeled by equations (5)-(6)

$$V = {K}_{e} {ω}_{m} + {Ri}_{a} + L \frac{d {i}_{a}}{d t} + {v}_{B} \qquad ( 5 )$$

$${T}_{e} = {K}_{e} {i}_{a} \qquad ( 6 )$$

where Kₑ, R, and L are the motor BEMF constant, resistance, and inductance, respectively; V, iₐ and Tₑ are the voltage input, current, and electromagnetic torque of the motor, v_{B} is the brush voltage drop, and ωₘ is the motor velocity.

The brush voltage drop v_{B} may be non-linear and can be described as set forth in equation (7):

$${v}_{B} = σ ( {i}_{a} ) {V}_{0} ( 1 - {e}^{- \vert \frac{{i}_{a}}{{I}_{0}} \vert} ) \qquad ( 7 )$$

where the term σ(iₐ) refers to the sign of current, and the quantities V₀ and I₀ are state variables of the function.

The disturbance term d is defined as the negative of the sum of the back-EMF Kₑωₘ and brush voltage drop v_{B} terms as equation (8):

$$d = - ( {K}_{e} {ω}_{m} + {v}_{B} ) \qquad ( 8 )$$

Further, the electrical parameters of the PMDC motor 26, 28, namely the back-EMF constant or torque constant Kₑ, resistance R, and inductance L vary dynamically with the operating condition of the PMDC motor 26, 28. The governing equation for parameter variations for a given magnet temperature θ_{Tm} can be expressed as equation (9):

$${K}_{e} = {γ}_{{K}_{e}} ( {K}_{en} ( 1 + {α}_{M} ( {θ}_{Tm} - {θ}_{n} ) ) ) \qquad ( 9 )$$

where γ_{K}_{ₑ} is a scaling factor accounting for magnetic saturation, and is a function of motor current iₐ. Further, α_{M} is a constant representing a thermal coefficient of the permanent magnet material used in the motor 26, 28.

Further, the inductance L of the PMDC motor 26, 28 can be described by equation (10):

$$L = {γ}_{L} {L}_{n} \qquad ( 10 )$$

where γ_{L} is a scaling factor for inductance based on the magnetic saturation characteristics of the PMDC motor 26, 28, and is a function of the motor current Iₐ.

Further yet, the motor circuit resistance R can be described by equation (11):

$$R = {R}_{FET} ( 1 + {α}_{Si} ( {θ}_{TSi} - {θ}_{n} ) ) + {R}_{m} ( 1 + {α}_{Cu} ( {θ}_{TCu} - {θ}_{n} ) ) \qquad ( 11 )$$

where R_{FET} is the nominal value of FET resistance, α_{Si} is a constant representing the thermal coefficient of silicon, θ_{TSi} is the temperature of the FETs at the operating condition, θₙ is the nominal temperature at which R_{FET} is measured, Rₘ is the nominal value of motor resistance, α_{Cu} is a constant representing the thermal coefficient of the copper windings, θ_{TCu} is the temperature of the windings at the operating condition, θₙ is the nominal temperature at which Rₘ is measured.

The equation above for the resistance provides the motor circuit resistance rather than the resistance of the motor windings only. In one or more examples, the aforementioned models of the parameter variations are employed to continuously estimate the motor parameters in real-time, or near real-time, which results in improved estimation of the signals used by the motor control system.

Further, the non-linear brush-drop term v_{B} can be linearized for specific application to the motor control system using a piece-wise observer structure may be employed. Alternatively, as mentioned earlier, the brush-drop term v_{B} along with BEMF can be cumulatively computed as the disturbance term d 240, which may be directly estimated using estimation techniques. It should be noted that the disturbance value d can be computed in presence of integral control for current regulation.

Accordingly, by computing the brush-drop term, the technical solutions herein further facilitate determining the observer behavior in terms of dynamic response, accuracy, and estimation of convergence speed.

The time domain model of the PMDC motor presented earlier may be transformed into the s-domain as equation (12):

$$V ( s ) = ( Ls + R ) {I}_{a} ( s ) + D ( s ) , \qquad ( 12 )$$

Another representation of the plant model of the electrical subsystem of the PMDC motor 26, 28 using state-space representation is given by equations (13)-(14), in continuous time.

$$\dot{x} = Ax + Bu + Ed \qquad ( 13 )$$

$$y = Cx \qquad ( 14 )$$

where x is a state vector including values of the current state of the EPS system 12, u is an input vector including measurable (and controllable) inputs to the EPS system 12, and D is the disturbance estimate 240, including measurable values that are not controllable, and typically non-linear in nature. Further, y is an output vector that is based on the current state x of the EPS system 12. A, B, C, and E, are configurable matrices which are setup to model the PMDC motor 26, 28 of the EPS system 12. In one or more examples, the matrices may be preconfigured.

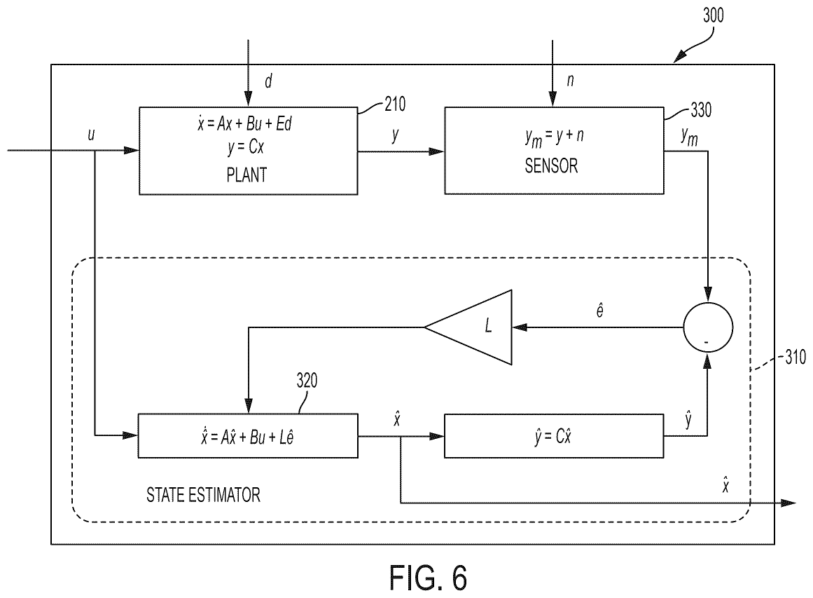

FIG. 6 illustrates one or more components and a data flow of a state observer module, according to one or more embodiments. The observer module 300 includes a state estimator 310 that computes or estimates one or more state variables of the plant model. As shown in the figure, the state estimator 310 drives a model 320 of the plant of the brushed PMDC motor 200 using the same control signal input applied to the plant module 210 and updates the state variables of the state estimator 310 until the state estimator outputs are driven to become equal to the measured system outputs. The state estimator 310 receives the measured system outputs, or intermediate signals, via one or more sensors 330. The estimated state variables may then be used for any purpose within the PMDC motor control system. In one or more examples, the state estimator 310 models the disturbance d 240 as a state variable.

In the depicted model, L is a matrix that includes observer gains, and is modified to achieve desired observer characteristics such as bandwidth. For example, for a linear observer, the gains are scalar values, and act upon a difference of the measured and estimated system outputs. It should be noted however, the present disclosure is not limited to such observers, and other observer structures such as non-linear estimators may also be employed. For instance, a sliding-mode observer may be employed where the state variables are updated on a scalar gain acting on the sign of the output error. Further, a reduced order implementation of the linear and non-linear observers may also be used for estimating the disturbance term and motor velocity.

Further, the disturbance estimate 240 is considered to be a state of the system 12 with an unknown initial condition. With this assumption, the unknown step function has a derivative of zero, and accordingly, the modified plant model may be written as equation (15):

$$\frac{d}{dt} [ \begin{matrix}{i}_{a} \\ d\end{matrix} ] = [ \begin{matrix}- \frac{R}{L} & \frac{1}{L} \\ 0 & 0\end{matrix} ] [ \begin{matrix}{i}_{a} \\ d\end{matrix} ] + [ \begin{matrix}\frac{1}{L} \\ 0\end{matrix} ] v \qquad ( 15 )$$

Further, a linear model for the disturbance observer module 410 is given by equation (16):

$$[ \begin{matrix}{\dot{\hat{ι}}}_{a} \\ \dot{\hat{d}}\end{matrix} ] = [ \begin{matrix}- \frac{\hat{R}}{\hat{L}} & \frac{1}{\hat{L}} \\ 0 & 0\end{matrix} ] [ \begin{matrix}{\hat{ι}}_{a} \\ \hat{d}\end{matrix} ] + [ \begin{matrix}\frac{1}{\hat{L}} \\ 0\end{matrix} ] v + [ \begin{matrix}{L}_{1} \\ {L}_{2}\end{matrix} ] ( {i}_{a} - {\hat{ι}}_{a} ) \qquad ( 16 )$$

where îₐ is the estimated current, \hat{d} is the estimated disturbance, \hat{R} is the estimated motor circuit resistance, \hat{L} is the estimated inductance, L₁ and L₂ are observer gains. Several different gain tuning strategies may be used for obtaining the observer gains, including Linear Quadratic Gaussian (LQG) estimator, pole placement etc. However, the technical solutions described herein implement the observer gain scheduling to facilitate an improved tune-ability resulting in a single tunable parameter. Specifically, the gains are selected such that the observer poles are a scalar x times faster than the plant poles. For example, the observer error estimates are given by equations (17)-(18):

$${\tilde{ι}}_{a} ( t ) = {i}_{a} ( t ) - {\hat{ι}}_{a} ( t ) \qquad ( 17 )$$

$$\tilde{d} ( t ) = d ( t ) - \hat{d} ( t ) \qquad ( 18 )$$

For example, in the case the estimated parameters are same as actual parameters, the error dynamics between the plant and observer are obtained as equation (19):

$$[ \begin{matrix}{\dot{\tilde{ι}}}_{a} \\ \dot{\tilde{d}}\end{matrix} ] = [ \begin{matrix}- \frac{\hat{R}}{\hat{L}} - {L}_{1} & \frac{1}{\hat{L}} \\ - {L}_{2} & 0\end{matrix} ] [ \begin{matrix}{\tilde{ι}}_{a} \\ \tilde{d}\end{matrix} ] \qquad ( 19 )$$

Comparing the characteristic equation of error dynamics matrix and a characteristic equation with roots that are x times faster than the

$$plant pole - \frac{R}{L} ,$$

observer gains L₁ and L₂ are given by equations (20)-(21):

$${L}_{1} = \frac{\hat{R}}{\hat{L}} ( 2 x - 1 ) \qquad ( 20 )$$

$${L}_{2} = \frac{{x}^{2} {\hat{R}}^{2}}{\hat{L}} \qquad ( 21 )$$

Thus, the observer equations are given by equation (22):

$$[ \begin{matrix}{\dot{\hat{ι}}}_{a} \\ \dot{\hat{d}}\end{matrix} ] = [ \begin{matrix}- \frac{\hat{R}}{\hat{L}} & \frac{1}{\hat{L}} \\ 0 & 0\end{matrix} ] [ \begin{matrix}{\hat{ι}}_{a} \\ \hat{d}\end{matrix} ] + [ \begin{matrix}\frac{1}{\hat{L}} \\ 0\end{matrix} ] v + [ \begin{matrix}\frac{\hat{R}}{\hat{L}} ( 2 x - 1 ) \\ \frac{{x}^{2} {\hat{R}}^{2}}{\hat{L}}\end{matrix} ] ( {i}_{a} - {\hat{ι}}_{a} ) \qquad ( 22 )$$

The observer stability and achievable bandwidth may be limited by the sample time of the control loop in which it is implemented. Accordingly, the calculation of the worst-case scalar k that may make the observer unstable is performed offline and used for limiting the tunable value of k so as to prevent instability. Further, it should be noted that the scalar k may further be scheduled as a function of multiple signals in the system, such as measured current, velocity estimate, vehicle speed and so on.

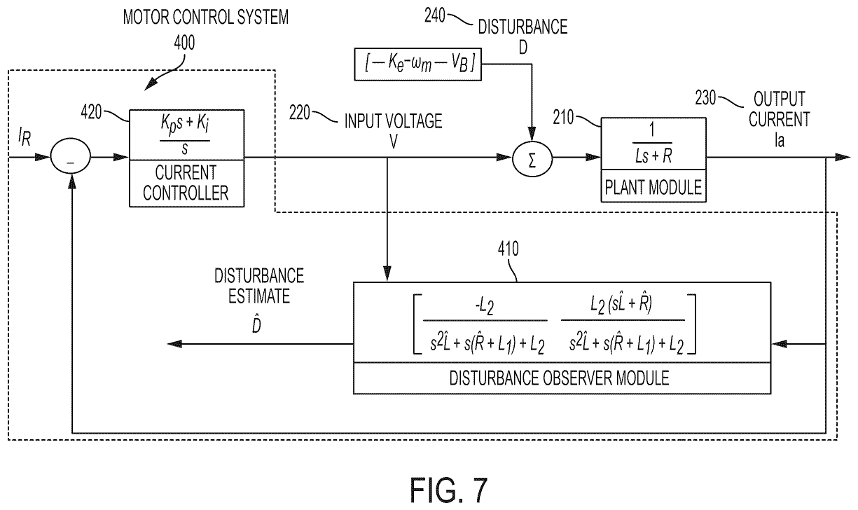

FIG. 7 illustrates a block diagram of an example motor control system 400 with the improvements facilitated by the technical features described herein. The motor control system 400 as illustrated includes, among other components, a disturbance observer module 410, and a current controller 420, in addition to the plant module 210. In one or more examples, the disturbance observer module 410 refers to the state estimator 310 from FIG. 6. In one or more examples, the components, such as the disturbance observer module 410 include hardware components, such as an ASIC, an FPGA, or the like. Alternatively, or in addition, the modules include computer executable instructions embedded on a memory that are executable by a processing unit, such as the control module 40.

In one or more examples, the current controller 420 is a PI controller that controls the input voltage signal V 220 being applied to the PMDC motor 26, 28 to generate the current I_{A} 230, and in turn the PMDC motor 26, 28 to operate at a desired velocity. The current controller 420 receives the current signal I_{R} as input, and also receives the output current I_{A} 230 as feedback to calculate an error term to control the input voltage signal V 220. As described herein, the disturbance D 240 affects the input voltage signal 220 after the current controller 420 has adjusted the input current reference or command Ip based on the feedback.

Therefore, to determine the disturbance D 240, the disturbance observer module 410 receives the voltage signal 220 and the output current I_{A} 230. The transfer matrix for the motor control system 200, as shown in the figure, is given by equation (23):

$$[ \hat{d} ] = [ \begin{matrix}{L}_{DV} ( s ) & {L}_{IV} ( s )\end{matrix} ] [ \begin{matrix}V \\ {I}_{M}\end{matrix} ] = [ \begin{matrix}\frac{- {L}_{2}}{{s}^{2} \hat{L} + s ( \hat{R} + {L}_{1} ) + {L}_{2}} & \frac{{L}_{2} ( s \hat{L} + \hat{R} )}{{s}^{2} \hat{L} + s ( \hat{R} + {L}_{1} ) + {L}_{2}}\end{matrix} ] [ \begin{matrix}V \\ {I}_{M}\end{matrix} ] \qquad ( 23 )$$

Accordingly, based on the above equation (23), the disturbance observer module 410 determines the disturbance value D 240 by based on the values input for the gain matrices L₁ and L₂. As described earlier, the gain matrices are made tunable to a single parameter by using a linear observer. Thus, the tune-ability of the motor control system to determine the disturbance value D 240 is improved through the gain scheduling of linear observer, resulting in a single scalar tunable parameter x described herein. The disturbance observer module 410 facilitates providing an improved dynamic performance, but similar steady-state sensitivity to modeling errors compared to motor control systems that use state observer modules without estimating the disturbance estimate 240.

FIG. 8 illustrates an example motor control system 400 that uses the computed disturbance estimate 240 to estimate the motor velocity signal, according to one or more embodiments. In addition to components described elsewhere, the brushed PMDC motor 200 includes a velocity module 510. The velocity module 510 receives the computed (or observed) output of the disturbance observer module 410, and extracts and outputs the motor velocity \hat{ω}ₘ. As described earlier, the disturbance estimate 240 is estimated based on equation (8).

Accordingly, the estimated motor velocity \hat{ω}ₘ is extracted by the velocity module 510 by using a model based (feedforward type) estimate of the brush-drop along with an estimate of Kₑ as follows set forth in equation (24):

$${\hat{ω}}_{m} = - \frac{\hat{d} + σ ( {i}_{a} ) {\hat{V}}_{0} ( 1 - {e}^{- \vert \frac{{i}_{a}}{{\hat{I}}_{0}} \vert} )}{{\hat{K}}_{e}} \qquad ( 24 )$$

where \hat{V}ₒ and Îₒ are estimated state variables of the function. It should be noted that, as used throughout the present document, the “hats” (\hat{ }) designate an estimated version of the true parameters.

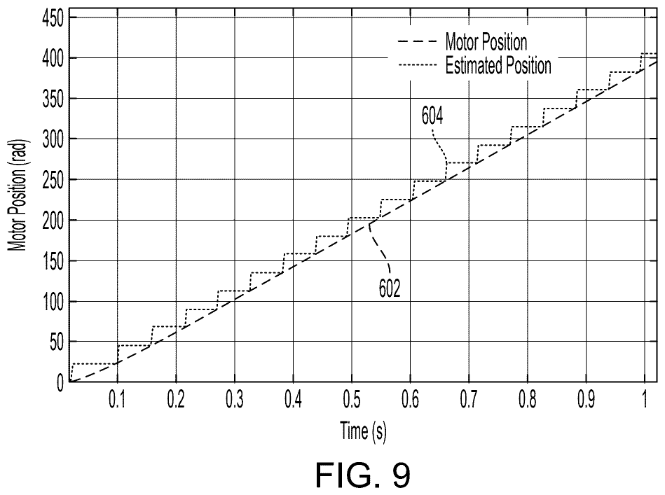

FIG. 9 shows a graph illustrating actual and estimated motor positions over time, according to aspects of the present disclosure. FIG. 9 includes a first plot 602 showing actual motor position and a second plot 604 showing an estimated position corresponding to the motor position signal \tilde{θ} from the position sensor 56. The resolution of the motor position signal \tilde{θ} may depend on a type of device used for the position sensor 56.

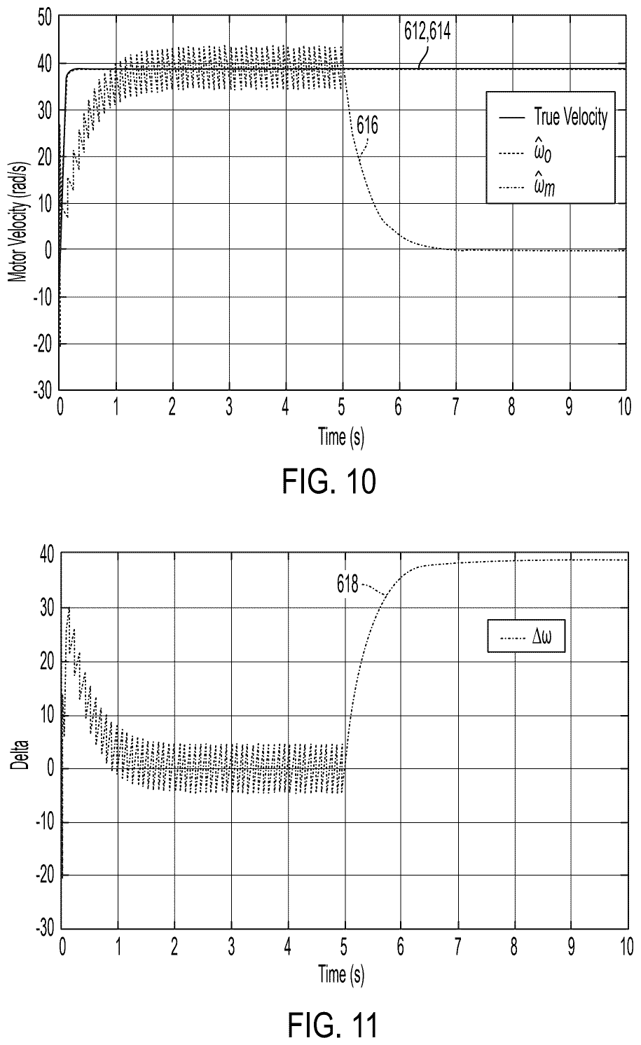

FIG. 10 shows a graph including a first plot 612 illustrating true velocity, a second plot 614 illustrating the observed velocity \hat{ω}ₒ velocity, and a third plot 616 illustrating the estimated motor velocity ωₘ, each over a common time scale of 0-10 seconds. As shown, the observed velocity \hat{ω}ₒ very closely tracks the true velocity such that the corresponding plots 612, 614 are barely distinguishable.

FIG. 11 shows a graph with a fourth plot 618 illustrating the difference velocity Δω over the same common time scale of the graph of FIG. 10. As shown in FIGS. 10-11, the estimated motor velocity \hat{ω}ₘ drops starting at time=5.0 seconds, indicating a failure of the position sensor 56. Beginning at that same time, the difference velocity Δω rapidly increases. This increasing of the difference velocity Δω may be used to determine the failure of the position sensor 56.

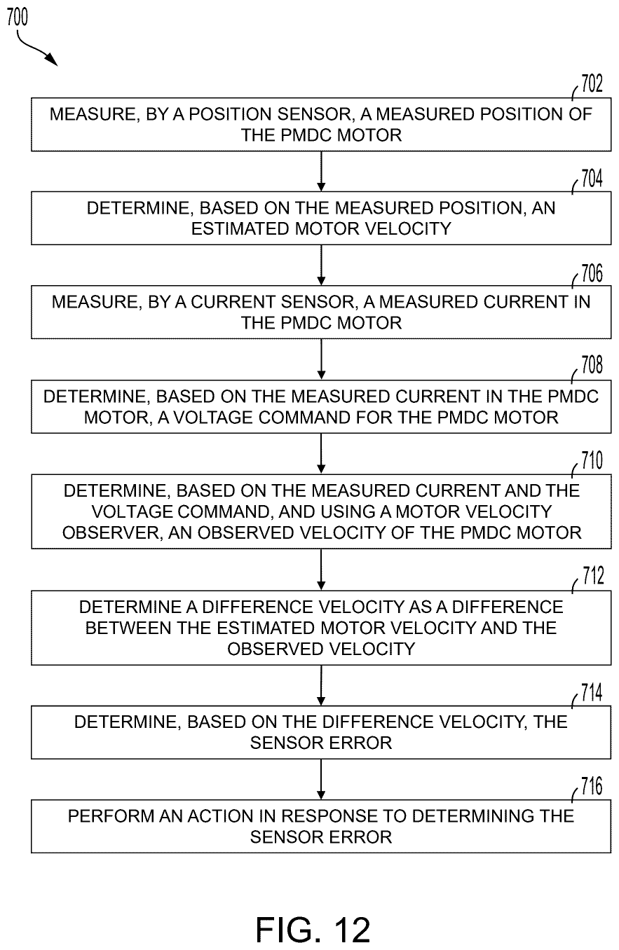

FIG. 12 shows a flow diagram listing steps in a method 700 of diagnosing a sensor error in an actuator having a PMDC motor, according to aspects of the present disclosure. The method 700 can be performed, at least in part, by the motor control system 50 of the present disclosure. As can be appreciated in light of the disclosure, the order of operation within the method is not limited to the sequential execution as illustrated in FIG. 12, but may be performed in one or more varying orders as applicable and in accordance with the present disclosure.

In some embodiments, the PMDC motor includes a brushed PMDC motor having brushes for transmitting DC current from a stationary terminal to a rotor winding.

In some embodiments, the PMDC motor may be an actuator motor configured to control a position of a handwheel of a steering system in a vehicle. However, the method 700 may be implemented for other PMDC motors in other applications.

At 702, the method 700 measures, by a position sensor, a measured position of the PMDC motor. For example, the position sensor 56 may measure a rotational position of the PMDC motor 26, 28 and transmit a motor position signal \tilde{θ} to the controller 60.

At 704, the method 700 determines, based on the measured position, an estimated motor velocity. For example, the processor 62 may execute instructions to implement the position estimator 72 and the velocity estimator 74 to compute the estimated motor velocity \hat{ω}ₘ based on the motor position signal \tilde{σ}.

At 706, the method 700 measures, by a current sensor, a measured current in the PMDC motor. For example, the current sensor 54 may measure the DC current supplied to the PMDC motor 26, 28 and to transmit a motor current signal Ĩ to the controller 60, representing an actual motor current in a winding of the PMDC motor 26, 28.

At 708, the method 700 determines, based on the measured current in the PMDC motor, a voltage command for the PMDC motor. For example, the processor 62 may execute instructions to implement the motor current controller 86 to determine the voltage command V* based on the estimated motor current Î.

At 710, the method 700 determines, based on the measured current and the voltage command, and using a motor velocity observer, an observed velocity of the PMDC motor. For example, the processor 62 may execute instructions to implement the motor velocity observer 84 to determine the observed velocity \hat{ω}ₒ based on the estimated motor current Î from the current estimator 82 and the voltage command V* from the motor current controller 86.

At 712, the method 700 determines a difference velocity as a difference between the estimated motor velocity and the observed velocity. For example, the processor 62 may execute instructions to implement the velocity difference calculator 90 to determine the difference velocity Δω as a difference between the observed velocity \hat{ω}ₒ and the estimated motor velocity \hat{ω}ₘ.

At 714, the method 700 determines, based on the difference velocity, the sensor error. For example, the processor 62 may execute instructions to implement the motion sensing error detector 94 to compare the difference velocity to a velocity error threshold and to selectively generate a fault signal F when the difference velocity Δω exceeds a velocity error threshold. Generating the fault signal F may, therefore, represent a determination of the sensor error.

In some embodiments, the method further includes adjusting the velocity error threshold based on an operating condition of the actuator. For example, the processor 62 may execute instructions to implement the adaptive threshold calculator 92 to adjust the velocity error threshold value.

In some embodiments, adjusting the velocity error threshold includes adjusting the velocity error threshold further based on the observed velocity. In some embodiments, adjusting the velocity error threshold includes increasing the velocity error threshold based on the observed velocity being less than a low velocity threshold value.

At 716, the method 700 performs an action in response to determining the sensor error. For example, the processor 62 may execute instructions to implement the motion sensing error detector 94 to compare the difference velocity to a velocity error threshold and to selectively generate a fault signal F when the difference velocity Δω exceeds a velocity error threshold. Additionally or alternatively, the processor 62 may further generate and/or store a diagnostic trouble code (DTC), notify an operator of the sensor error, to communicate the sensor error and/or perform an action to mitigate an effect of the sensor error.

The present disclosure provides a method of diagnosing a sensor error in an actuator having a permanent magnet DC (PMDC) motor. The method includes: measuring, by a position sensor, a measured position of the PMDC motor; determining, based on the measured position, an estimated motor velocity; measuring, by a current sensor, a measured current in the PMDC motor; determining, based on the measured current in the PMDC motor, a voltage command for the PMDC motor; determining, based on the measured current and the voltage command, and using a motor velocity observer, an observed velocity of the PMDC motor; determining a difference velocity as a difference between the estimated motor velocity and the observed velocity; determining, based on the difference velocity, the sensor error; and performing an action in response to determining the sensor error.

In some embodiments, determining the sensor error further includes comparing the difference velocity to a velocity error threshold, and the method further includes adjusting the velocity error threshold based on an operating condition of the actuator.

In some embodiments, adjusting the velocity error threshold includes adjusting the velocity error threshold further based on the observed velocity.

In some embodiments, adjusting the velocity error threshold includes increasing the velocity error threshold based on the observed velocity being less than a low velocity threshold value.

In some embodiments, the PMDC motor includes a brushed PMDC motor having brushes for transmitting DC current from a stationary terminal to a rotor winding.

In some embodiments, the PMDC motor is an actuator motor configured to control a position of a handwheel of a steering system in a vehicle.

In some embodiments, performing the action in response to determining the sensor error includes at least one of: generating a diagnostic trouble code and notifying an operator of the sensor error.

In some embodiments, performing the action in response to determining the sensor error includes performing an action to mitigate an effect of the sensor error.

The present disclosure provides a motor control system. The motor control system includes: a position sensor configured to measure a measured position of a PMDC motor; a current sensor configured to measure a measured current in the PMDC motor; and a controller. The controller is configured to: determine, based on the measured position, an estimated motor velocity; determine, based on the measured current in the PMDC motor, a voltage command for the PMDC motor; determine, based on the measured current and the voltage command, and using a motor velocity observer, an observed velocity of the PMDC motor; determine a difference velocity as a difference between the estimated motor velocity and the observed velocity; determine, based on the difference velocity, a sensor error; and perform an action in response to determining the sensor error.

In some embodiments, the controller is further configured to: compare the difference velocity to a velocity error threshold, and adjust the velocity error threshold based on an operating condition of the PMDC motor.

In some embodiments, the controller is configured to adjust the velocity error threshold further based on the observed velocity.

In some embodiments, the controller is configured to increase the velocity error threshold based on the observed velocity being less than a low velocity threshold value.

In some embodiments, the PMDC motor includes a brushed PMDC motor having brushes for transmitting DC current from a stationary terminal to a rotor winding.

In some embodiments, the PMDC motor is an actuator motor configured to control a position of a handwheel of a steering system in a vehicle.

In some embodiments, performing the action in response to determining the sensor error includes the controller performing at least one of: generating a diagnostic trouble code and notifying an operator of the sensor error.

In some embodiments, performing the action in response to determining the sensor error includes the controller performing an action to mitigate an effect of the sensor error.

The present disclosure provides a motor control system. The motor control system includes: a position sensor configured to measure a measured position of a PMDC motor; a current sensor configured to measure a measured current in the PMDC motor; a processor; and a memory. The memory includes instructions that, when executed by the processor, cause the processor to: determine, based on the measured position, an estimated motor velocity; determine, based on the measured current in the PMDC motor, a voltage command for the PMDC motor; determine, based on the measured current and the voltage command, and using a motor velocity observer, an observed velocity of the PMDC motor; determine a difference velocity as a difference between the estimated motor velocity and the observed velocity; determine, based on the difference velocity, a sensor error; and perform an action in response to determining the sensor error.

In some embodiments, the instructions further cause the processor to: compare the difference velocity to a velocity error threshold, and adjust the velocity error threshold based on an operating condition of the PMDC motor.

In some embodiments, the instructions further cause the processor to adjust the velocity error threshold further based on the observed velocity.

In some embodiments, the instructions further cause the processor to increase the velocity error threshold based on the observed velocity being less than a low velocity threshold value.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in scope with the present disclosure. Additionally, while various embodiments of the present disclosure have been described, it is to be understood that aspects of the present disclosure may include only some of the described embodiments or combinations of the various embodiments. Accordingly, the present disclosure is not to be seen as limited by the foregoing description.

What is claimed is:

1. A method of diagnosing a sensor error in an actuator having a permanent magnet DC (PMDC) motor, comprising:
measuring, by a position sensor, a measured position of the PMDC motor;
determining, based on the measured position, an estimated motor velocity;
measuring, by a current sensor, a measured current in the PMDC motor;
determining, based on the measured current in the PMDC motor, a voltage command for the PMDC motor;
determining, based on the measured current and the voltage command, and using a motor velocity observer, an observed velocity of the PMDC motor;
determining a difference velocity as a difference between the estimated motor velocity and the observed velocity;
determining, based on the difference velocity, the sensor error; and
performing an action in response to determining the sensor error.

2. The method of claim 1, wherein determining the sensor error further includes comparing the difference velocity to a velocity error threshold, and wherein the method further includes adjusting the velocity error threshold based on an operating condition of the actuator.

3. The method of claim 2, wherein adjusting the velocity error threshold includes adjusting the velocity error threshold further based on the observed velocity.

4. The method of claim 3, wherein adjusting the velocity error threshold includes increasing the velocity error threshold based on the observed velocity being less than a low velocity threshold value.

5. The method of claim 1, wherein the PMDC motor includes a brushed PMDC motor having brushes for transmitting DC current from a stationary terminal to a rotor winding.

6. The method of claim 1, wherein the PMDC motor is an actuator motor configured to control a position of a handwheel of a steering system in a vehicle.

7. The method of claim 1, wherein performing the action in response to determining the sensor error includes at least one of: generating a diagnostic trouble code and notifying an operator of the sensor error.

8. The method of claim 1, wherein performing the action in response to determining the sensor error includes performing an action to mitigate an effect of the sensor error.

9. A motor control system, comprising:
a position sensor configured to measure a measured position of a PMDC motor;
a current sensor configured to measure a measured current in the PMDC motor; and
a controller configured to:
determine, based on the measured position, an estimated motor velocity;
determine, based on the measured current in the PMDC motor, a voltage command for the PMDC motor;
determine, based on the measured current and the voltage command, and using a motor velocity observer, an observed velocity of the PMDC motor;
determine a difference velocity as a difference between the estimated motor velocity and the observed velocity;
determine, based on the difference velocity, a sensor error; and
perform an action in response to determining the sensor error.

10. The motor control system of claim 9, wherein the controller is further configured to:
compare the difference velocity to a velocity error threshold, and
adjust the velocity error threshold based on an operating condition of the PMDC motor.

11. The motor control system of claim 10, wherein the controller is configured to adjust the velocity error threshold further based on the observed velocity.

12. The motor control system of claim 11, wherein the controller is configured to increase the velocity error threshold based on the observed velocity being less than a low velocity threshold value.

13. The motor control system of claim 9, wherein the PMDC motor includes a brushed PMDC motor having brushes for transmitting DC current from a stationary terminal to a rotor winding.

14. The motor control system of claim 9, wherein the PMDC motor is an actuator motor configured to control a position of a handwheel of a steering system in a vehicle.

15. The motor control system of claim 9, wherein performing the action in response to determining the sensor error includes the controller performing at least one of: generating a diagnostic trouble code and notifying an operator of the sensor error.

16. The motor control system of claim 9, wherein performing the action in response to determining the sensor error includes the controller performing an action to mitigate an effect of the sensor error.

17. A motor control system, comprising:
a position sensor configured to measure a measured position of a PMDC motor;
a current sensor configured to measure a measured current in the PMDC motor;
a processor; and
a memory that includes instructions that, when executed by the processor, cause the processor to:
determine, based on the measured position, an estimated motor velocity;
determine, based on the measured current in the PMDC motor, a voltage command for the PMDC motor;
determine, based on the measured current and the voltage command, and using a motor velocity observer, an observed velocity of the PMDC motor;
determine a difference velocity as a difference between the estimated motor velocity and the observed velocity;
determine, based on the difference velocity, a sensor error; and
perform an action in response to determining the sensor error.

18. The motor control system of claim 17, wherein the instructions further cause the processor to:
compare the difference velocity to a velocity error threshold, and
adjust the velocity error threshold based on an operating condition of the PMDC motor.

19. The motor control system of claim 18, wherein the instructions further cause the processor to adjust the velocity error threshold further based on the observed velocity.

20. The motor control system of claim 19, wherein the instructions further cause the processor to increase the velocity error threshold based on the observed velocity being less than a low velocity threshold value.
